(19) United States
(12) Patent Application Publication
(10) Pub. No.: US 2020/0065314 A1
(43) Pub. Date: Feb. 27, 2020

(54) A METHOD, APPARATUS AND COMPUTER PROGRAM PRODUCT FOR USER-DIRECTED DATABASE CONFIGURATION, AND AUTOMATED MINING AND CONVERSION OF DATA

(71) Applicant: UNIVERSITY OF FLORIDA RESEARCH FOUNDATION, INC., Gainesville, FL (US)

(72) Inventor: Robert Vernon PHILLIPS, Gainesville, FL (US)

(21) Appl. No.: 16/461,078

(22) PCT Filed: Dec. 6, 2017
(86) PCT No.: PCT/IB2017/057694

§ 371 Date: May 15, 2019

Related U.S. Application Data
(60) Provisional application No. 62/443,043, filed on Jan. 6, 2017.

(51) Int. Cl. G06F 16/25; G06F 16/84; G06F 16/28; G06F 16/2455; G06F 16/81

(52) U.S. Cl. CPC G06F 16/258; G06F 16/84; G06F 16/81; G06F 16/2455; G06F 16/284

(57) ABSTRACT

A method, apparatus, and computer program product are provided for user-directed database configuration, and automated mining and conversion of structured data, such as XML, to a relational database. A user provides object types for which data-base tables are to be generated, and corresponding fields of interest to include as columns in the database tables. The fields of interest may include attributes or descendant object types of the indicated object type. The database tables are generated according to the user configuration and are automatically populated with the corresponding data values from XML files. The database may therefore be populated only with data needed by the user. Unnecessary data tables and columns may therefore be limited, thereby reducing the use of database storage space and improving the efficiency of database queries.

### TECHNOLOGICAL FIELD

An example embodiment of the present invention relates generally to data analysis, and more particularly, to a method, apparatus and computer program product for user-directed configuration of a database, and automated mining and conversion of data.

### BACKGROUND

In the past several decades, the amount of digital information collected or generated and stored for subsequent use has increased immensely. Extensive repositories are developed and maintained by various marketing companies, data mining companies, data brokers and/or the like. The data is often converted to a standard format for redistribution and consumption by other systems or researchers.

XML (extensible markup language) is one such format that is prevalent in many academic and scientific areas as a means to represent and transmit data. A researcher of XML data is often faced with the task of analyzing hundreds or thousands of XML documents of similar format, where each XML document is considered to be human-readable and machine-readable. In some instances, however, the volume of data provided may exceed an amount that could reasonably be processed and analyzed by a human.

Various XML shredding processes have been implemented to parse XML data into relational databases, enabling easier data analysis, reporting, and graphics generation. However, in some instances, the complexity of and inconsistencies within the XML objects may result in a large number of under-utilized database tables. The depth of a node in an XML structure amongst other unneeded objects may result in a thinly spread database design and wasted database memory. Rare occurrences of optional attributes or descendent objects within the XML documents may further result in XML shredders creating a large number of database tables containing only one record, or a relatively small number of records in comparison to other tables.

A database model generated by XML shredders and other parsers may therefore result not only in wasted database memory but also in inefficient access to the desired data in the database. However, in many cases, the researcher may have (or may easily acquire by a brief review of the documents) knowledge of the objects expected to occur in the XML files, including an idea of the frequency in which certain attributes or descendent nodes may appear at all. The researcher may also have an understanding of what data will be useful, and what data may not be needed.

### BRIEF SUMMARY

A method, apparatus, and computer program product are therefore provided for providing user-directed database configuration, and automated mining and conversion of structured data, such as XML, to a relational database. In this regard, a user may provide the desired object types and list of associated fields of interest occurring in a data source, set of source files or structured data (e.g., XML files). For each object and attribute, the user provides the path, such as an XPath expression indicating the position of the object or attribute within the structured document or XML hierarchy. Example embodiments may then process the user input to generate table creation statements. The structured data may be further processed such that the data from the structured data can be inserted into the database tables.

For example, the XML files may be processed to generate output files comprising the data to be inserted into the tables. Bulk insert statements may be generated such that when processed with the output files, the data from the output files is inserted into the appropriate table. XML files may be referred to hereinafter as the structured data processed according to example embodiments, but it will be appreciated that any type of structured data configured in a hierarchical or structured format similar to that provided by XML may also be processed according to example embodiments. The structured data may include source files and/or any data received via a data stream.

A method is provided according to embodiments provided herein. The method includes receiving an indication of at least one object type for retrieval from structured data and receiving an indication of at least one field of interest corresponding to each of the indicated object types. The method further includes determining for each indicated object type and field of interest, a path indicating the respective locations of the indicated object types and the fields of interest within the structured data, and creating a database table for each indicated object type. The method may then include extracting, by a processor, data from the structured data, wherein the data extracted from the structured data represents instances of the indicated object types and the fields of interest, wherein extracting the data uses respective paths indicating respective locations of the indicated object types and the fields of interest in the structured data. The method further includes inserting the data extracted from the structured data into the created database tables.

In some embodiments, creating the database table for each indicated object type includes generating, based on the at least one indicated object type and the corresponding fields of interest, table creation statements configured for generating a database table for indicated each object type. In some embodiments, creating the database table for a particular indicated object type further includes identifying a primary key based on a relation of the particular indicated object type to other indicated object types of the one or more indicated object types.

The primary key is identified according to the following. In an instance the particular indicated object type represents a highest level tier of the relation, the method includes generating the respective database table such that an additional field is created and is identified as a sole field of the primary key. The method may further include, in an instance the particular indicated object type does not represent the highest level tier of the relation, identifying the primary key as a combination of at least two table fields.

In some examples, inserting the data includes generating, for each indicated object type, an output file from the data extracted from the structured data, the output file comprising instances of the respective indicated object type and data values for each of the corresponding fields of interest, generating a set of bulk insert statements configured for inserting the data values from the output files into the generated database tables, and

processing the set of bulk insert statements to cause the inserting of the data values into the created database tables.

In some examples, at least one of the indicated object types, the fields of interest, or the paths are received via user input. According to example embodiments, the structured data includes hierarchical data. The fields of interest may comprise at least one of an attribute or a descendent object type of the indicated object type. The structured data may include Extensible Markup Language (XML) files and the paths are XPath expressions.

According to example embodiments, the method may include receiving additional structured data, and processing the additional structured data to insert additional data into the created database tables.

An apparatus is also provided. The apparatus includes at least one processor and at least one memory including computer program code, the at least one memory and the computer program code configured to, with the processor, cause the apparatus to at least receive an indication of at least one object type for retrieval from structured data, receive an indication of at least one field of interest corresponding to each of the indicated object types, and determine for each indicated object type and field of interest, a path indicating the respective locations of the indicated object types and the fields of interest within the structured data. The at least one memory and the computer program code are further configured to create a database table for each indicated object type, extract data from the structured data, wherein the data extracted from the structured data represents instances of the indicated object types and the fields of interest, wherein extracting the data uses respective paths indicating respective locations of the indicated object types and the fields of interest in the structured data, insert the data extracted from the structured data into the created database tables.

A computer program product is also provided according to embodiments provided herein. The computer program product comprises at least one non-transitory computer-readable storage medium having computer-executable program code instructions stored therein, the computer-executable program code instructions comprising program code instructions to receive an indication of one or more object types for retrieval from structured data, receive an indication of one or more fields of interest corresponding to each of the indicated object types, and determine for each indicated object type and field of interest, a path indicating the respective locations of the indicated object types and the fields of interest within the structured data. The computer-executable program code instructions further include program code instructions to create a database table for each indicated object type, extract data from the structured data, wherein the data extracted from the structured data represents instances of the indicated object types and the fields of interest, wherein extracting the data uses respective paths indicating respective locations of the indicated object types and the fields of interest in the structured data, and insert the data extracted from the structured data into the created database tables.

An apparatus is also provided, with means for receiving an indication of at least one object type for retrieval from structured data and means for receiving an indication of at least one field of interest corresponding to each of the indicated object types. The apparatus further includes means for determining for each indicated object type and field of interest, a path indicating the respective locations of the indicated object types and the fields of interest within the structured data, and means for creating a database table for each indicated object type. The apparatus further includes means for extracting data from the structured data, wherein the data extracted from the structured data represents instances of the indicated object types and the fields of interest, wherein extracting the data uses respective paths indicating respective locations of the indicated object types and the fields of interest in the structured data. The apparatus further includes means for inserting the data extracted from the structured data into the created database tables.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 is an overview of a system that can be used to practice certain embodiments described herein;

FIG. 2 is an exemplary schematic diagram of an apparatus according to some example embodiments; and

FIGS. 3-5 are flowcharts illustrating operations performed in accordance with some example embodiments.

### DETAILED DESCRIPTION

Various embodiments now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

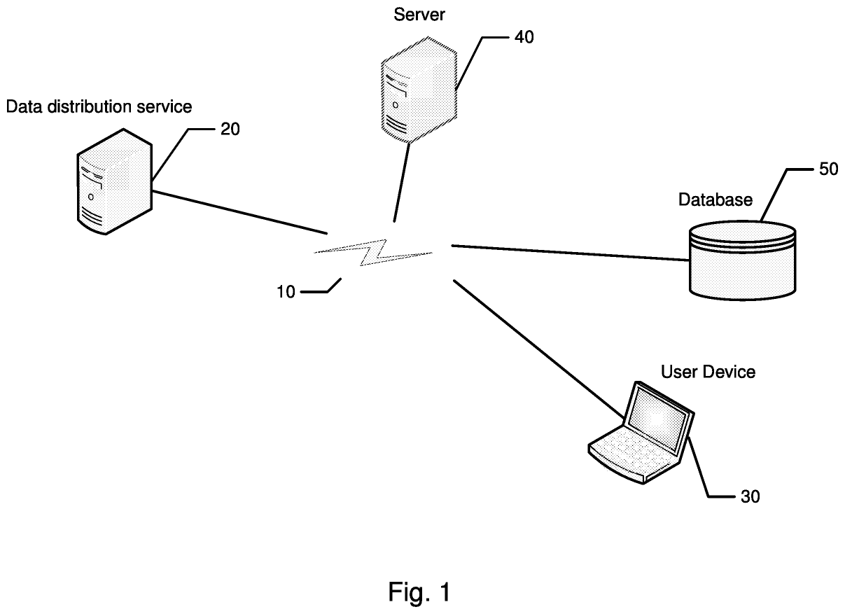

As described below, a method, apparatus and computer program product are provided for providing user-directed database configuration, and for the automated mining and conversion of data. FIG. 1 is an overview of a system that can be used to practice certain embodiments described herein, and should not be considered limiting.

As illustrated in FIG. 1, example embodiments may be implemented as or employed in a distributed system. The various depicted components may be configured to communicate over a network 10, such as the Internet, for example, or any other communication interface as described in further detail hereinafter.

In general, a data distribution service 20 may provide structured data to a requesting system, server, or like computing device. The data distribution service 20 may be configured as a digital library, or web service, for example, for providing structured data in a standardized format such as XML. While XML is referred to herein as a common example of structured data, the structured data may include any digital data including but not limited to hierarchical data. The structured data may therefore include nested hierarchies of elements or nodes. For example, the structured data may be represented in formats such as JSON (JavaScript Object Notation), YAML (sometimes referred to as Yet Another Markup Language), and Protobuf. The structured data may include any expression syntax sufficient for the given data format to indicate a node or list of nodes within a hierarchy. The structured data may include any data from one or more source files, data streams, and/or the like. The structured data may include data received via a data interchange and/or data serialization formats, including but not limited to API results access via the Internet, for example. In some examples, the structured data may be included in sources files stored locally or accessed remotely over a network.

According to one non-limiting example referred to herein, a publisher may provide (via data distribution service 20, for example) thousands of XML files that include structured data (e.g., metadata) describing scholarly articles. The structure data and/or metadata is represented as XML code in the structured data, such as the example XML provided in Table 1 below.

TABLE 1

| | |
|---|---|
| 1 | <article> |
| 2 | <title> A lengthy discussion of science </title> |
| 3 | <publication_name> Biosensors and Bioelectronics </publication_name> |
| 4 | <cover_date>15 January 2015 </cover_date> |
| 5 | <citation_count> 9 </citation_count> |
| 6 | <author> |
| 7 | <author_name> Jane Doe </ author_name > |
| 8 | <affiliation> |
| 9 | <name> General Hospital XYZ </name> |
| 10 | <city> Fuzhou </city> |
| 11 | <country> China </country> |
| 12 | </affiliation> |
| 13 | <affiliation> |
| 14 | <name> University XYZ </name> |
| 15 | <city> Xiamen </city> |
| 16 | <country> China </country> |
| 17 | </affiliation> |
| 18 | <affiliation> |
| 19 | <name> Medical University ABC </name> |
| 20 | <city> Fuzhou</city> |
| 21 | <country> China </country> |
| 22 | </affiliation> |
| 23 | </author> |
| 24 | </article> |

A researcher, or user, operating a user device 30 may access the XML files, view the files, and utilize the XML files in various studies. The researcher may be given various research tasks to glean statistics from a set of such articles. Some sample tasks might include the following: show a histogram of how many articles were published in each month represented among the XML files; show a table of how many articles were published for each publication name; show a table of article counts by month by publication; show a correlation of article citation counts by cover date; show the average number of affiliations given in the inputs over all the articles for each publication.

As mentioned above, a researcher may employ various XML shredding processes to convert the structured data to database tables. However, the database tables generated by an XML shredder may require a researcher to write lengthy and complex query statements in order to access the desired data, due to the poor design of the database table schema generated by the shredder. The generated database design may be characteristic of a thinly sprawled architecture and underutilized tables. In addition to requiring advanced querying techniques to access the desired data, execution of queries and reports may be subject to slow response times, timeouts by the database, and other inefficiencies.

However, according to example embodiments provided herein, a user, with user device 30, may indicate the desired object types and associated fields of interest occurring in the XML files such that the database tables are created on database 50, are more intelligently designed, and are tailored for the researcher's desired use.

Based on the user-specified configuration, the structured data (e.g., XML files) may be processed by a server 40, as described herein according to example embodiments, to generate an efficient database table schema on database 50. The data may then be mined from the structured data, source file and/or data stream accordingly, such as by server 40. The resultant data may be stored on database 50, enabling more efficient access and querying from user device 30.

The system of FIG. 1 described above is provided merely as an example implementation and it will be appreciated that the example embodiments provided herein may be implemented as or employed by any number of system architectures.

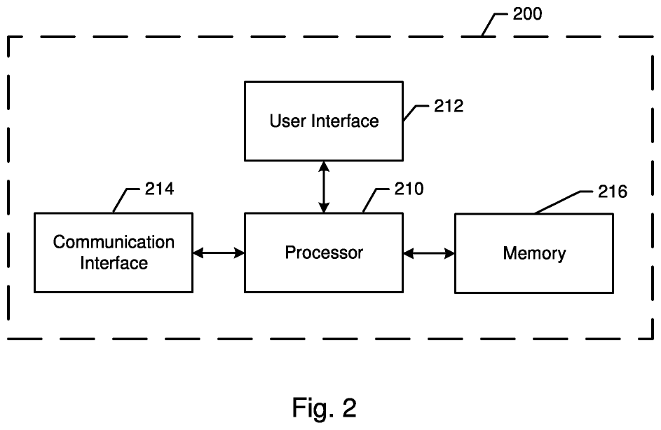

Referring now to FIG. 2, apparatus 200 is a computing device(s) configured for providing user-directed database configuration, and automated mining and conversion of data according to example embodiments. Apparatus 200 may at least partially or wholly embody any of the network 10, data distribution service 20, user device 30, server 40, and/or database 50 described above.

Apparatus 200 may include or otherwise be in communication with a processor 210, user interface 212, communication interface 214, and memory 216. As describe above, apparatus 200 may be implemented as a distributed system for performing the operations described herein. As such, any of the components such as the processor 210, user interface 212, communication interface 214, and memory 216, or portion(s) thereof, may be distributed across multiple computing devices and may be collectively configured to operate as apparatus 200. As such, the various operations described herein may indeed be performed by different computing devices.

The processor 210 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments processor 210 comprises a plurality of processors. The plurality of processors may be embodied on a single computing device, such as server 40, or may be distributed across a plurality of computing devices collectively configured to function as the processor 210. The plurality of processors may be in operative communication with each other and may be collectively configured to perform one or more functionalities as described herein. In an example embodiment, processor 210 is configured to execute instructions stored in memory 216 or otherwise accessible to processor 210. These instructions, when executed by processor 210, may cause the apparatus 200 to perform one or more of the functionalities as described herein.

Whether configured by hardware, firmware/software methods, or by a combination thereof, processor 210 may comprise an entity capable of performing operations according to the example embodiments described herein. Thus, for example, when processor 210 is embodied as an ASIC, FPGA or the like, processor 210 may comprise specifically configured hardware for conducting one or more operations described herein. Alternatively, as another example, when processor 210 is embodied as an executor of instructions, such as may be stored in memory 216, the instructions may specifically configure processor 210 to perform one or more algorithms and operations described herein.

Memory 216 may comprise, for example, volatile memory, non-volatile memory, or some combination thereof. Although illustrated in FIG. 2 as a single memory, memory 216 may comprise a plurality of memory components. The plurality of memory components may be embodied on a single computing device or distributed across a plurality of computing devices. Memory 216 may include database, 50, for example, and/or any memory components of data distribution service 20, user device 30, and/or server 40. In various embodiments, memory 216 may comprise at least a non-transitory medium such as but limited to a hard disk, random access memory, cache memory, flash memory, a compact disc read only memory (CD-ROM), digital versatile disc read only memory (DVD-ROM), an optical disc, circuitry configured to store information, or some combination thereof. Memory 216 may be configured to store information, data (including XML files, database tables, etc.), applications, instructions, or the like for enabling apparatus 200 to carry out various functions in accordance with example embodiments described herein. For example, in at least some embodiments, memory 216 is configured to buffer input data for processing by processor 210. Additionally or alternatively, in at least some embodiments, memory 216 is configured to store program instructions for execution by processor 210. Memory 216 may store information in the form of static and/or dynamic information. This stored information may be stored and/or used by apparatus 200 during the course of performing its functionalities.

Communication interface 214 may be embodied as any device or means embodied in circuitry, hardware, a computer program product comprising computer readable program instructions stored on a computer readable medium (e.g., memory 216) and executed by a processing device (e.g., processor 210), or a combination thereof that is configured to receive and/or transmit data from/to another device and/or network, such as, for example, a second apparatus 200 and/or the like. In some embodiments, communication interface 214 (like other components discussed herein) can be at least partially embodied as or otherwise controlled by processor 210. In this regard, communication interface 214 may be in communication with processor 210, such as via a bus. Communication interface 214 may include, for example, an antenna, a transmitter, a receiver, a transceiver, network interface card and/or supporting hardware and/or firmware/software for enabling communications with another local or remote computing device and/or servers. Communication interface 214 may include a network (e.g., network 10), such as any wired or wireless communication network including a local area network (LAN), personal area network (PAN), wide area network (WAN), the Internet, an intranet, or the like, as well as any attendant hardware, software and/or firmware required to implement said networks (e.g. network routers and network switches). Communication interface 214 may be configured to receive and/or transmit any data that may be provided by computing devices such as the data distribution service 20, for example, using any protocol that may be used for communications between computing devices. Communication interface 214 may be further configured, for example, to write data to database 50. Communication interface 214 may additionally or alternatively be in communication with the memory 216, user interface 212 and/or any other component of apparatus 200, such as via a bus.

User interface 212 may be in communication with processor 210 to receive an indication of a user input and/or to provide an audible, visual, mechanical, or other output to a user. As such, user interface 212 may include, for example, a keyboard, a mouse, a user device, a computer, a display, and/or other input/output mechanisms. In embodiments in which apparatus 200 is embodied as a distributed system, user interface 212 may be implemented on a user device, such as user device 30, that may be separate from a server or other computing device configured to perform at least some of the operations described herein. For example, at least some aspects of user interface 212 may be embodied on an apparatus used by a user that is in communication with apparatus 200. For example, the user interface 212 may be implemented at least partially on a user device, such as user device 30, and may be configured for viewing XML files and/or receiving user inputs, such as the names of object types and associated fields of interest occurring in XML files. The user interface 212 may be in communication with memory 216, communication interface 214, and/or any other component(s), such as via a bus. One or more than one user interfaces 212 can be included in apparatus 200.

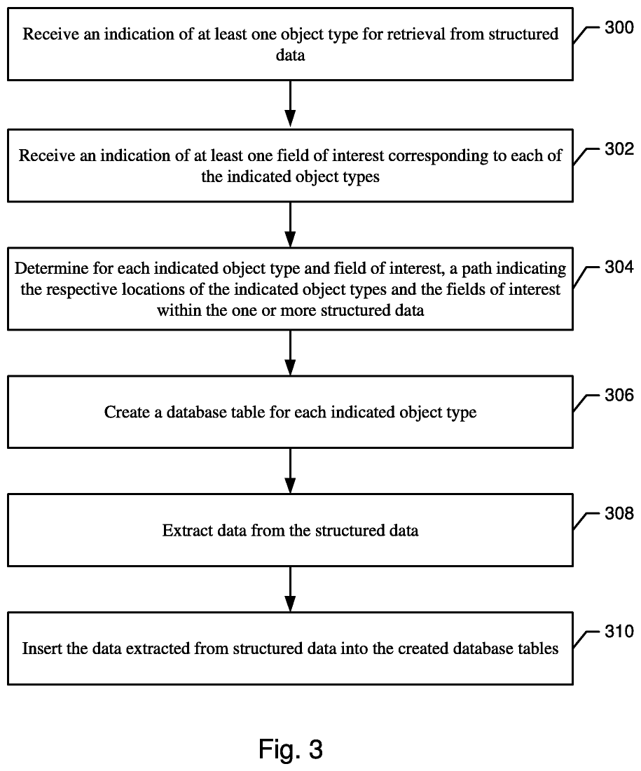

FIG. 3 is a flowchart of operations performed by apparatus 200 according to some example embodiments. As shown by operation 300, apparatus 200, such as with processor 210, user interface 212, communication interface 214, memory 216 and/or the like, receives an indication of at least one object type for retrieval from structured data. The indication of at least one object type may include user-indicated object type(s), and may include object type(s) of interest to the user, such as based on requirement for a particular study. For example, a user examining structured data such as XML files provided by data distribution service 20, and/or stored on memory 216 may provide user input identifying the names of object types (e.g., names of XML element types indicated by XML tags) present in the XML files. The indicated object types may include only a subset of available object types in the XML files based on what the user wishes to study, or may include all of the available object types.

Based on the example XML in Table 1 relating to data provided by a publisher, and considering the data desired by the user, the user may enter the object types of ‘article’ and ‘affiliation’, to request creation of respective database tables. In this example, the user is interested in data relating to articles and affiliations, but is not necessarily interested in the ‘author’ or ‘author name’ object types shown in lines 6 and 7 of Table 1.

The user may additionally provide a location in memory at which the structured data may be accessed, such as on the user device 30 and/or server 40. For example, the user may indicate an input directory of “c:/mydata/sample-data” to indicate the location of the XML files.

At operation 302, apparatus 200, such as with processor 210, user interface 212, communication interface 214, memory 216 and/or the like, receives an indication of at least one field of interest corresponding to each of the indicated object types. For example, a user may provide, via user input to a user device 30 and/or user interface 212, names for fields corresponding to the indicated object types specified in operation 300. The fields of interest may therefore be an attribute, such as an XML attribute of a corresponding object type, an object's text content (content of an XML object), and/or a descendent object types nested at any level within the indicated object type indicated in operation 300. In some examples, a field of interest may even include an attribute (e.g., XML attribute) of a descendent object or its text content. In general, the fields of interest may include only the fields the user wants to include as table fields in the database table to be created for the object type indicated in operation 300. The fields of interest may therefore include only a subset of the available attributes and available descendent object types present in the structured data (e.g., XML files). As used herein, the term attribute may be considered any attribute value, and/or text content of an object, node, and/or tag.

The fields of interest may, for example, occur at any depth within the object structure (e.g., XML object structure), such that the user is not necessarily required to adhere to the same structure defined by the document (e.g., XML source file). In this regard, some available attributes and/or descendent objects may be excluded from the provided set of fields of interest indicated by the user. For instance, in the provided example, the object type of ‘author’ may be excluded in the fields of interest corresponding to the object type of ‘article’.

In some examples, attributes and/or descendent objects nested in varying levels within the object structure (e.g., a child node of the object type, a grandchild node of the object type, etc.) may be provided by the user for association with a single object type. In such examples, the user requests configuration of the database representing a different relational hierarchy than that represented in the structured data (e.g., XML source file(s)).

Referring to the example of Table 1, a user can enter the fields of interest of ‘cover_date’, ‘publication_name’, and ‘citation_count’ to be included in a table for the object type ‘article’. As another example, the fields of interest ‘name’, ‘city’, and ‘country’ may be provided for the object type ‘affiliation’.

At operation 304, apparatus 200, such as with processor 210, user interface 212, communication interface 214, memory 216 and/or the like, determines for each indicated object type and field of interest, a path indicating the respective locations of the indicated object types and the fields of interest within the source XML files. In some examples, the path may be provided by the user via user device 30 and/or user interface 22. As mentioned above, the user may indicate fields of interest occurring at different levels with an XML object. The paths of each object and indicated field of interest may therefore be provided by the user. For example, a path may be indicated with an XPath expression. In some examples, the user may determine a path for each indicated object type and field of interest, and some XPath expressions may be defined to generate more than one object field value. The user may have defined some fields of interest for some objects that are derived programmatically by example embodiment. For example a field ‘city_country’ may also have been defined for the affiliation object type, and example embodiments may be configured to derive this value from some customized column value-generating function or computer-implemented method that combines the independent city and country attributes when the mining process performed by example embodiments encounters the second of the XPath expressions that indicate the XML attributes for city and country. When such a custom column function is utilized, it may access all prior column values so far mined for the particular object, on which to base its output value.

The XPath expression for the path of the object type ‘article’ may be “//article,” and the XPath expression for the path for the object type ‘affiliation’ may be “//article/author/affiliation.”

Although not utilized in the present example, an XPath expression for an XML attribute ‘xyz’ of object type ‘abc’ may be abc/@xyz. The XPath query language therefore allows the user to configure the apparatus 200 to mine any desired data from the XML files, whether occurring as an XML attribute or descendent XML object (child, grandchild, etc.).

In some examples, XPaths that would specify @attribute_name are indicated without the ‘@attribute’ suffix to the XPath, but rather by indicating the attribute name in the ‘attribute_column’ dictionary parameter that contains the each interesting attribute name paired with the database object column name to use. Using the ‘attribute_column’ dictionary also provide the mechanism for renaming attribute names in the XML to database column names, sometimes required to avoid using attribute names that are not syntactically honored by the relational database (e.g., names with hyphens in them). Also this type of renaming may be needed where the same attribute name is used on a mined node and a mined descendent node that use the same attribute name, but that is desired to be mined into separate column names relating to the same object.

As another example, the apparatus 200 may process the XML file with processor 210 such that the apparatus 200 determines the paths of the indicated object types and attributes by searching for the names of indicated object types and/or attributes, and identifying their positions relative to other objects. For example, some complex XML files may have an XML tag with the same tag name under different hierarchies. The XML tag <name> may exist under various hierarchies, for example, <author>, <city>, <state> . . . and several more in one XML source file, so a user of example embodiments may indicate which of the object types were of interest, if not all were wanted. Otherwise, common XML shredders may process the entire XML file set to generate a database table schema for all encountered data. Example embodiments may therefore limit or avoid such a complexity. For instance, if in fact within the structured data, no duplicate object types (e.g., XML tag names) are present under different hierarchies, then processing or finding all objects could be performed by parsing each tree (e.g., XML tree) of each indicated object type and determining the relative hierarchy position of a particular indicated object type is in a consistent position in all source files of a set. After this initial parsing, the structured data (e.g., XML source files), the set of all found potential tables and column (e.g., field) names could be displayed and a user could pick and choose which tables and columns within tables that they want to extract.

At operation 306, apparatus 200, such as with processor 210, communication interface 214, memory 216 and/or the like, creates a database table for each indicated object type. In this regard, a database table may be created, such as on memory 216 and/or database 50. The table may be created such that the table is named based on the indicated object type, and/or any other name provided by the user. The table may be created such that a table includes respective columns (e.g., table fields) for each of the fields of interest that were indicated by the user in operation 302.

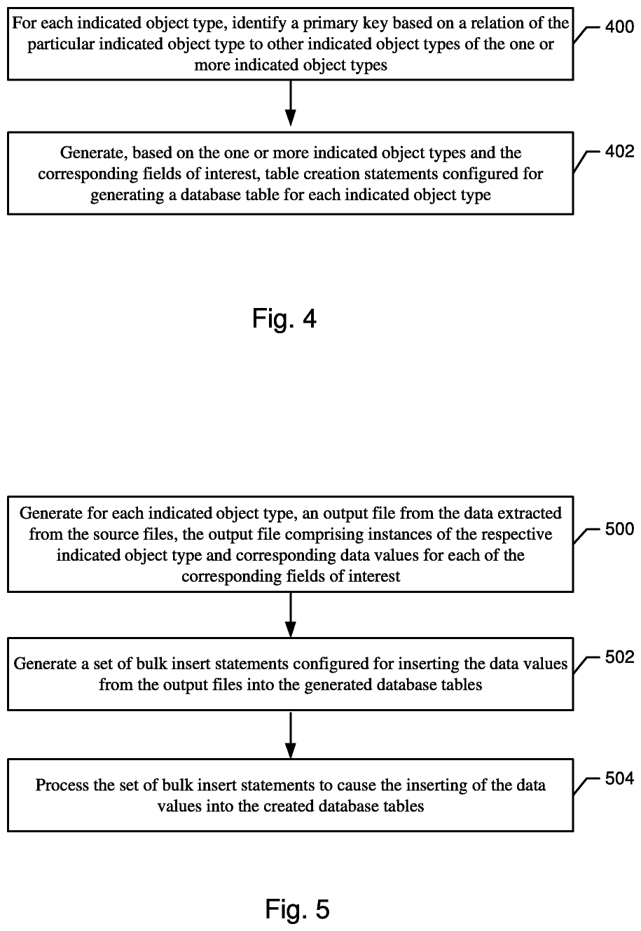

In some examples, apparatus 200 may include one or more additional fields not indicated by the user as fields of interest. Any such additional fields may be created in order to provide a unique identifier or primary key for the corresponding table and to establish a relationship between that table and other tables. For example, if apparatus 200 identifies an object type as the highest level indicated object type in the relational hierarchy of the object types indicated by the user, a column or table field may be added to the corresponding table such that a unique identifier for each record may be inserted. In some examples multiple additional fields may be created to generate a primary key. Therefore, table creation may be based on a processing of the structured data to determine relationships with other tables and to ensure the columns created within the table are sufficient for establishing such relationships. This process is described in further detail below with respect to FIG. 4, which provides operations for creating a database table.

In operation 308, apparatus 200, such as with processor 210, memory 216 and/or the like, extracts data from the structured data. For example, processor 210 may process each of a set of source XML files, such as those in the location of memory 216 specified by the user. The source XML files may be parsed and/or processed to extract instances of an indicated object type requested by the user in operation 300. The data extracted from the structured data represents instances of the indicated object types and the fields of interest. Extracting the data uses respective paths indicating respective locations of the indicated object types and the fields of interest in the structured data.

Continuing to operation 310, apparatus 200, such as with processor 210, communication interface 214, memory 216 and/or the like, inserts the data extracted from the structured data into the created database tables. Each object instance from the source XML files may thereafter be inserted as a record in the database table, with the values of the specified fields of interest being inserted into the respective columns or table fields. Additionally or alternatively, the data extracted for each database table may be saved to a separate file for each table in such a format that simple SQL commands may later be invoked to load the tables into the target database.

In some examples, the order of a mining map (e.g., provided paths) and/or the order in which the data is extracted may be important, as this may dictate the order of mining, and the caching of result column values for a particular relational table ‘row’—which may be required for a column function to operate correctly to generate a desired derived value for an output field.

In some embodiments, in addition to inserting data values extracted from the XML file, an enumerator may be used to generate a unique identifier for each data record inserted in a table and in order to populate the additional fields generated by the apparatus 200. The enumeration may be performed in conjunction with operation 308, such that as the data is parsed, the specific instances are counted. Using an enumerator to populate a column in a table may also satisfy the need for a primary key. Again, this process is described in further detail below with respect to FIG. 4.

The operations set forth in FIG. 3 may be performed such that a database table is created for each object type indicated by the user, and that instances of the object present in the XML files are inserted into the respective tables along with data values of the respective fields of interest. As a result, the database 50 may include tables designed by the user, but which are automatically populated by the processor 210 with data from the XML files.

In some embodiments, some of the operations of FIG. 3 may be repeated on a routine basis to facilitate the insertion of data into the database as it is provided from a third party source, such as data distribution service 20. For example, operations 308 and 310 may be performed on a routine basis, such as nightly, for example, or as a routine batch process. Newly received XML files or additionally received XML files may then be processed and the data comprised therein inserted into the tables.

FIG. 4 is a flowchart of operations for creating a database table according to example embodiments, such as described in operation 306 above. The database table may be created by generating a table creation statement indicating fields for the table and a primary key.

For example, a table creation statement, such as in SQL (Structured Query Language), for creating a table by the name of author, is provided below in Table 2.

TABLE 2

1 create table affiliation(
2 article_index integer
3 ,affiliation_instance_id integer
4 ,name nvarchar(3550)
5 ,city nvarchar(3550)
6 ,country nvarchar(3550)
7 CONSTRAINT pk_affiliation
PRIMARY KEY(article_index, affiliation_instance_id));

The table creation statement shown in Table 2 defines a primary key. In operation 400, the apparatus 200, such as with processor 210, memory 216 and/or the like, identifies a primary key for each table to be created (e.g., for each indicated object type), based on a relation of the particular indicated object type to other indicated object types of the indicated object types. In this regard, the CONSTRAINT statement in line 7 of Table 2 indicates that the combination of table fields ‘article’, and ‘affiliation_instance_id’ create a unique pair that is the primary key of table ‘affiliation’.

Apparatus 200, such as with processor 210, may identify the columns or table fields that together serve as the primary key by processing the relation of the object type within the structured data (e.g., XML document) to determine which table fields, when combined, will provide a unique identifier or primary key for the table. For example, for a given object for which apparatus 200 is identifying a primary key, the apparatus 200, such as with processor 210, may identify each database table to be generated in operation 306 that correspond to an ancestral object of interest of the given object. The primary key for the database table corresponding to the given object may be identified as the combination of all the fields that are indexes identifying the ancestral objects of interest, and the instance identifier of the given object. In this regard, the objects of interest are meant to specify that the other objects considered as related to a given object may be limited to include those indicated by the user. An object that is not of interest to the user may not be included in a primary key of any of the generated tables.

The statement in line 7 generated to create the primary key may be included in the table creation statement described below with respect to operation 402. In this regard, based on the primary keys, the apparatus 200 automatically creates hierarchical interrelated indexes in the database table. Setting the primary key of the ‘affiliation’ table as the pair of ‘article_index’, and ‘affiliation_instance_id’ indicates the hierarchical relationship between an article and affiliation (e.g., that several affiliations could be related to an article).

In this regard, in an instance the particular indicated object type represents a highest level tier of the relation of the particular indicated object type to other indicated object types for which tables were requested, the apparatus 200 generates the respective database table (e.g., with the table creation statement described in further detail below) such that an additional table field is created and is identified as a sole table field of an alternate unique key. In an instance the particular indicated object type does not represent the highest level tier of the relation, the apparatus 200 identifies the primary key as a combination of at least two table fields. The combination of the at least two table fields may include the instance identifiers and indexes of the related ancestral objects (e.g., parent, grandparent, etc.) for which tables will be created.

Example embodiments may also generate SQL directives to create proper foreign key indexes. Accordingly, example embodiments may therefore identify a foreign key based on the parent tables with the same primary keys except the last one of the subject table being created.

In operation 402, the apparatus 200, such as with processor 210, memory 216 and/or the like generates, based on the indicated object types and the corresponding fields of interest, table creation statements configured for generating a database table for each indicated object type. The table creation statement provides the columns or table fields to be included in the database table that correspond to the fields of interest indicated by the user in operation 302. The columns may further include other integer-valued columns corresponding to integer primary key fields containing objects of higher relational tiers (e.g., ancestral objects) for which a table will be generated, and also an integer instance identifier (e.g., affiliation_instance_id) of the object itself relative to the closest ancestral node that will be represented in the database or as identified from the at least one indicated object type provided by the user. For example, the instance identifier may identify the instance of the object relative to its parent node from the XML file, (or grandparent node when the parent is not utilized, for example). The additional table fields are added as a means for creating a primary key constraint, described in further detail below.

For example, based on the structure of the source XML file and/or the paths provided by the user, the apparatus 200 and/or processor 210 determines that an object of type ‘affiliation’ is a descendent of the XML object type of ‘article’. An article represents the highest tier object or table of interest of the two requested tables, and an affiliation is a descendent object of an article such that multiple instances of an affiliation may be associated with an article. The apparatus 200 therefore generates the column ‘article index’ to include a unique identifier or index of the article record in the ‘article’ table describing the article in which the affiliation was identified. The apparatus 200 generates the column of ‘affiliation instance id’ to populate a unique identifier (such as with an enumerator) for the particular instance of the affiliation within the article.

Although the object type of ‘author’ is the parent of affiliation, the user is not interested in the author so no column for the author is needed.

The processor 210 may generate the table creation statement, such as the one above, such that each column is named as indicated by the user according to the field of interest, or defaulted to, for example, the name of the field of interest in the XML file (e.g., XML descendent object type or XML attribute name). For the field ‘affiliation_instance_id’, the processor 210 may generate the column name, such as ‘<table name>+“_instance_id”’ or by any other similar naming convention. The processor 210 may further generate the datatype (such as ‘integer’, “nvarchar’, etc.) and/or the size allocated memory size for the table field based on user input, and/or by inferring the datatype and/or size from parsing the data in the XML file.

Further, in some examples, the order of the table creation statements may be generated and/or processed such that when a table is created, all tables on which its foreign key depends have already been created in the sequence. Otherwise the database may disallow table creations.

In some embodiments, the table creation statements generated by apparatus 200 may be processed by a database management system, such as Microsoft SQL Server, or SQL Server Management Studio, to generate the table in a database, such as database 50. In some examples, the user may copy and paste the table creation statements into a program such as any of the aforementioned systems, which may execute the statements to create the tables. In some examples, the statements may be processed automatically by apparatus 200 to generate the tables.

Having now described the user configuration and resulting generation of the database tables, FIG. 5 is a flowchart of operations for inserting data from the XML files into the database tables. At operation 500, the apparatus 200, such as with processor 210, memory 216 and/or the like, generates, for each indicated object type, an output file from the data extracted from the structured data. The output file comprises instances of the respective indicated object type and corresponding data values for each of the corresponding fields of interest.

It will be appreciated that the generation of an output file may be considered an optional intermediary step performed by apparatus 200. As another example, the data described as being written to the output file may indeed be extracted from the XML files as described, but may then be stored temporarily using volatile memory, following which the data is inserted into the database without requiring the generation an output file, for example. Generating the output files and storing the output files on non-volatile memory, however, as described below, may provide the advantage of creating an archive or backup of the data as it is mined from the XML files and inserted into the database. In some embodiments, another advantage of generating an output file includes that it may be advantageous to delay the insertion of data into the database to avoid times when the database is in heavy operation.

Apparatus 200 may generate an output file having a .txt file extension and named as the corresponding indicated object type. The output file may be stored on memory 216 in a location specified by the user, for example. The processor 310 may parse the XML file using the XPath to extract instances of the indicated object type. The processor 310 may further determine the data values for each corresponding field of interest using the respectively provided paths for the fields of interest. The values may then be extracted, mined, or parsed from the XML files and then written to the output file, which may be formatted with a specified delimiter (e.g., line break, or ‘n’) separating each instance or record, and a different delimiter (e.g., tab, or ‘t’) separating each data value. Continuing with the example introduced above, Table 3 is the contents of an example output file for the database table ‘article’.

TABLE 3

| article_index | affiliation_instance_id | name | city | country |
|---|---|---|---|---|
| 1 | 1 | General Hospital XYZ | Fuzhou | China |
| 1 | 2 | University XYZ | Xiamen | China |
| 1 | 3 | Medical University ABC | Fuzhou | China |

As can be seen in Table 3, three affiliations are associated with the article having an article_index of ‘1’. The corresponding article record could be identified in the ‘article’ table using the article_index. The output file represents the data that will be inserted into the database table.

At operation 502, the apparatus 200, such as with processor 210, memory 216 and/or the like, generates a set of bulk insert statements configured for inserting the data values from the output files into the generated database tables. Table 4 provides an example bulk insert statement in SQL that may be generated by apparatus 200:

TABLE 4

1 BULK INSERT affiliation
2 FROM ‘c:/output_files /affiliation.txt’
3 WITH (FIELDTERMINATOR =‘\t’,
ROWTERMINATOR = ‘\n’);

The example bulk insertion statement in Table 4 may be processed such that the data from the output file in the indicated location, ‘c:/output_files/affiliation.txt’ is inserted into the ‘affiliation’ table. The file location may be generated based on the location of the output file provided by a user, and/or the indicated object type, for example. In some examples a default output file location may be used.

At operation 504, the apparatus 200, such as with processor 210, memory 216 and/or the like, processes the set of bulk inserts statements to cause the inserting of the data values into the respective database tables. In some examples, the user may initiate the processing of the bulk insert statements. As another example, apparatus 200 may be configured to execute the bulk insert statement on a routine basis. In this regard, the apparatus 200 may process the bulk insert statement with a variable file name, such as one including a timestamp of the current day, for example.

Example embodiments therefore provide automated mining and conversion of the data into a relational database designed based on user configuration. The user may utilize a data analysis tool to query the database and generate the desired analyses, reports, and graphics. The data analysis tool may utilize SQL, and may include example products such as Microsoft SQL Server, Oracle, R, SAS, and D3.js, for example. A variety of statistical reporting software is available for use for researchers to formulate their own queries and reports.

Enabling the user to provide user input that specifies the desired tables and fields of interest to include in each table prevents or limits the creation of “spaghetti” tables. The user configuration provides for promotion of data values from singly-occurring or scarcely occurring XML descendent objects or attributes to a table corresponding to an ancestral node (e.g., parent node, grandparent node, great-grand parent node, etc.) any number of levels upward in the XML hierarchy. This may considerably reduce the need for unnecessarily complex or confusing levels of hierarchy in the generated SQL table schemas and in downstream SQL query constructions.

In contrast to the efficiencies in schema design enabled by example embodiments described herein, traditional XML shredders may alternatively traverse each and every object and attribute of an XML file, including optional attributes that may only occur as a single instance, or in a very low percentage, such as less than 1%, of the total number of objects. Such XML shredders may therefore generate numerous linked but underused tables, some of which may only include a few records. For example, in the example scenario provided herein, an XML shredder that does not employ example embodiments described herein would generate an ‘author’ table which was not needed by the user in this particular example.

An additional benefit of example embodiments includes that a constant column output value may be generated when a particular XML object type is present. For example, consider structured data similar to the structured data provided in Table 1. An example embodiment may identify that a tag <x> always appears immediately after the <article> tag, and </x> appears immediately before </article>. Further, an example embodiment may determine that in the set of structured data, instead of ‘x’, example embodiments identify that the tag name at that position is always one of <digital>, <audio>, <print>, or <video>, representing a media type. However, an example embodiment may determine that none of the aforementioned tags has any attribute values (which may include the tag's or node's text content) nor text content. An example embodiment may therefore add a column ‘media_type’ to the ‘article’ object. For the XPath that indicates the <digital> tag example embodiments inserts a (column,constant) pair of (‘media_type’, 1). For the XPath that indicates <audio> example embodiments insert (‘media_type’, 2), and likewise for <print> and <video> example embodiments insert media type constants of 3 and 4. Example embodiments can therefore encode this type of data that appears in some styles of structured data (e.g., XML source files). Note that a user may also indicated or choose (‘media_type’, ‘digital’) for digital using the actual tag names. As another example, if a user does not want to distinguish audio from video in the database, the user could indicate that the columns should have the same inserted constant value.

Furthermore, example embodiments allow for a wide range of configuration or manipulation of the data by the user. For example, a user may direct the apparatus 200 to convert all values to upper or lower case for a given column. As another example, a user may direct the apparatus 200 to combine multiple attributes or object values into one column (e.g., first and last name combined to full name), parse one object into multiple columns (e.g., parse a first and last name from a full name), and/or perform calculations among any subset of values to insert data as sums, averages, counts, Levenshtein distance measurements, etc. Still further, the user may provide a user input indicating a default value for a particular column, such that in an instance in which an attribute does not exist or is not calculable, the default value is inserted into the column.

Based on the above, many modifications of example embodiments may be contemplated. For example, it will be appreciated that the embodiments provided herein may be modified such that the apparatus 200 parses the XML sources files or other structured data, and determines the desired indicated object types (e.g., database tables) and fields of interest (e.g., table fields) based on a predefined or user-provided threshold. For example, as suggested above, XML objects having an optional attribute or particular descendent node occurring in less than 1% of the object instances may be identified by apparatus 200, such that the apparatus 200 prevents creation of a table for the scarcely occurring attribute or descendent node. Rather, the apparatus 200 may include the scarcely occurring attribute or descendent node as a table field in a database table relating to an ancestral object type, which may be optionally populated (or populated only when it is present within a particular XML object instance). In this regard, the “spaghetti” database tables and thinly spread database architectures may be limited, but the data is still captured in the relevant records.

Example embodiments may therefore provide for user customization paired with automated extraction to provide a compact database model, occupying less database memory and enabling more efficient access to the desired data in comparison to alternative methods which may otherwise include every object and attribute from the sources files. In this regard, the user may access the generated database tables to run reports, generate graphics, and perform other queries in a more efficient manner, thereby conserving processing resources. As such, the method, apparatus and computer program product provide numerous technical advantages including the conservation of memory, processing resources and the associated power consumption otherwise expended to support the creation of and access to tables otherwise generated by a fully automated XML shredder which may include every object and attribute embedded in the structured data.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
receiving an indication of at least one object type for retrieval from structured data;
receiving an indication of at least one field of interest corresponding to each of the indicated object types;
determining for each indicated object type and field of interest, a path indicating the respective locations of the indicated object types and the fields of interest within the structured data;
creating a database table for each indicated object type;
extracting, by a processor, data from the structured data, wherein the data extracted from the structured data represents instances of the indicated object types and the fields of interest, wherein extracting the data uses respective paths indicating respective locations of the indicated object types and the fields of interest in the structured data; and
inserting the data extracted from the structured data into the created database tables.

2. The method of claim 1, wherein creating the database table for each indicated object type comprises:
generating, based on the at least one indicated object type and the corresponding fields of interest, table creation statements configured for generating a database table for each indicated object type.

3. The method of claim 1, wherein creating the database table for a particular indicated object type further comprises identifying a primary key based on a relation of the particular indicated object type to other indicated object types of the one or more indicated object types.

4. The method of claim 3, wherein the primary key is identified by:
in an instance the particular indicated object type represents a highest level tier of the relation, generating the respective database table such that an additional field is created and is identified as a sole field of the primary key; and
in an instance the particular indicated object type does not represent the highest level tier of the relation, identifying the primary key as a combination of at least two table fields.

5. The method of claim 1, wherein inserting the data comprises:
generating, for each indicated object type, an output file from the data extracted from the structured data, the output file comprising instances of the respective indicated object type and data values for each of the corresponding fields of interest;
generating a set of bulk insert statements configured for inserting the data values from the output files into the generated database tables; and
processing the set of bulk insert statements to cause the inserting of the data values into the created database tables.

6. The method of claim 1, wherein at least one of the indicated object types, the fields of interest, or the paths are received via user input.

7. The method of claim 1, wherein the structured data comprises hierarchical data.

8. The method of claim 1, wherein the structured data comprises Extensible Markup Language (XML) files and the paths are XPath expressions.

9. The method of claim 1, wherein the fields of interest comprise at least one of an attribute or a descendent object type of the indicated object type.

10. The method of claim 1, further comprising:
receiving additional structured data; and
processing the additional structured data to insert additional data into the created database tables.

11. An apparatus comprising at least one processor and at least one memory including computer program code, the at least one memory and the computer program code configured to, with the processor, cause the apparatus to at least:
receive an indication of at least one object type for retrieval from structured data;
receive an indication of at least one field of interest corresponding to each of the indicated object types;
determine for each indicated object type and field of interest, a path indicating the respective locations of the indicated object types and the fields of interest within the structured data;
create a database table for each indicated object type;
extract data from the structured data, wherein the data extracted from the structured data represents instances of the indicated object types and the fields of interest, wherein extracting the data uses respective paths indicating respective locations of the indicated object types and the fields of interest in the structured data; and
insert the data extracted from the structured data into the created database tables.

12. The apparatus of claim 11, wherein creating the database table for each indicated object type comprises:
generate, based on the one or more indicated object types and the corresponding fields of interest, table creation statements configured for generating a database table for each indicated object type.

13. The apparatus of claim 11, wherein creating the database table for a particular indicated object type further comprises identifying a primary key based on a relation of the particular indicated object type to other object types of the one or more indicated object types.

14. The apparatus of claim 13, wherein the primary key is identified by:
in an instance the particular indicated object type represents a highest level tier of the relation, generating the respective database table such that an additional field is created and is identified as a sole field of the primary key; and
in an instance the particular indicated object type does not represent the highest level tier of the relation, identifying the primary key as a combination of at least two table fields.

15. The apparatus of claim 11, wherein inserting the data comprises:
generating, for each indicated object type, an output file from the data extracted from the structured data, the output file comprising instances of the respective indicated object type and data values for each of the corresponding fields of interest;
generating a set of bulk insert statements configured for inserting the data values from the output files into the generated database tables; and
processing the set of bulk insert statements to cause the inserting of the data values into the created database tables.

16. The apparatus of claim 11, wherein at least one of the indicated object types, the fields of interest, or the paths are received via user input.

17. The apparatus of claim 11, wherein the structured data comprises hierarchical data.

18. The apparatus of claim 11, wherein the fields of interest comprise at least one of an attribute or a descendent object type of the indicated object type.

19. The apparatus of claim 11, wherein the at least one memory and the computer program code are further configured to cause the apparatus to at least:
receive additional structured data; and
process the additional structured data to insert additional data into the created database tables.

20. A computer program product comprising at least one non-transitory computer-readable storage medium having computer-executable program code instructions stored therein, the computer-executable program code instructions comprising program code instructions to:
receive an indication of one or more object types for retrieval from structured data;
receive an indication of one or more fields of interest corresponding to each of the indicated object types;
determine for each indicated object type and field of interest, a path indicating the respective locations of the indicated object types and the fields of interest within the structured data;
create a database table for each indicated object type;
extract data from the structured data, wherein the data extracted from the structured data represents instances of the indicated object types and the fields of interest, wherein extracting the data uses respective paths indicating respective locations of the indicated object types and the fields of interest in the structured data; and
insert the data extracted from the structured data into the created database tables.
